(19) United States
(12) Patent Application Publication
(10) Pub. No.: US 2010/0029492 A1
(43) Pub. Date: Feb. 4, 2010

(54) NUCLEIC ACID CHIP FOR OBTAINING BINDING PROFILE OF SINGLE STRAND NUCLEIC ACID AND UNKNOWN BIOMOLECULE, MANUFACTURING METHOD THEREOF AND ANALYSIS METHOD OF UNKNOWN BIOMOLECULE USING NUCLEIC ACID CHIP

(75) Inventor: Sung-Chun KIM, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: KOREA TECHNOLOGY INDUSTRY CO., LTD., Seoul (KR)

(21) Appl. No.: 12/566,544

(22) Filed: Sep. 24, 2009

Related U.S. Application Data
(63) Continuation of application No. PCT/KR2007/002810, filed on Jun. 11, 2007.

(51) Int. Cl. C40B 30/00; C40B 50/14; C40B 40/08

(52) U.S. Cl. 506/7; 506/30; 506/17

(57) ABSTRACT

Disclosed are a nucleic acid chip for obtaining binding profiles between unknown biomolecules and single-stranded nucleic acids, a method for manufacturing the chip, and a method for analyzing the unknown biomolecules using the chip. The nucleic acid chip is used to analyze biological significance of the unknown biomolecule in the biospecimen. The nucleic acid chip can be manufactured by reacting a biospecimen containing an unknown biomolecule with random single-stranded nucleic acids having random base sequences to determine biomolecule-binding single stranded nucleic acids capable of binding the unknown biomolecule; and synthesizing capture single stranded nucleic acids composed of the determined biomolecule-binding single stranded nucleic acids and/or single stranded nucleic acids having base sequences complementary to those of said determined biomolecule-binding single stranded nucleic acids and affixing the capture single stranded nucleic acids on a substrate.

### CROSS REFERENCE TO RELATED APPLICATION

The present application is a continuation of International Application Number PCT/KR2007/002810 filed Jun. 11, 2007, the disclosure of which is hereby incorporated by reference herein in its entirety.

### TECHNICAL FIELD

The present invention relates to a nucleic acid chip for obtaining binding profiles between unknown biomolecules and single-stranded nucleic acids, a method for manufacturing the same, and a method for analyzing the unknown biomolecules using the same.

### BACKGROUND ART

With an advance in physics, biochemistry and bioinformatics, many techniques for obtaining profiles of unknown biomolecules such as proteins and carbohydrates have been developed. In spite of such technologies, however, there is a high need for a novel and efficient method and instrument due to problems regarding the use, maintenance cost, feasibility, accuracy, sensibility, required testing time and process automation ability of the existing methods and devices.

A method for producing comprehensive information on quantitative states of an unknown biomolecule in a biospecimen, that is, a profile of the unknown biomolecule, which is not an ultimate object, but a means to approach the object, finds a wide range of applications in various fields including medicine, veterinary science, environmental engineering, food engineering, the agriculture industry and the like thanks to the ability thereof to identify unknown biomolecules in microorganisms, viruses, cells and tissues.

A nucleic acid is a linear polymer of covalently linked nucleotides, each consisting of a phosphoric acid, a sugar and a purine (adenine or guanine) or a pyrimidine (cytosine, thymidine or uracil). A nucleic acid exists as single or double strands in which nucleotides form hydrogen bonds and interact therebetween to form a unique stereo-structure on the basis of the base sequence thereof.

Nucleic acids, such as deoxyribonucleic acids (DNAs) and ribonucleic acids (RNAs), are reservoirs of information for the expression of proteins which serve as enzymes and components of cellular structures. Since the discovery in 1982 that RNA can form complex secondary structures with enzymatic activity, many reports on structural characteristics of RNA and their corresponding functions have been published.

Nucleic acids, consisting of repeating units of four bases, exist in the form of an extensive variety of stereo-structures with high diversity, which interact with specific substances to form stable complexes.

Some nucleic acids can act as ligands for specific molecules including proteins. From a library of single-stranded nucleic acids having various base sequences, nucleic acids capable of binding to specific molecules with high affinity and specificity can be selected by a selection process and base sequencing.

Nucleic acid ligands, termed aptamers, have been identified from a random nucleic acid library to be able to bind to a wide variety of specific molecules, such as proteins, with high affinity and specificity using in vitro iterative selection techniques, called Systemic Evolution of Ligands by Exponential enrichment (SELEX) (Tuerk C. and Gold L.; Science, 249, pp 505-510, 1990).

SELEX allows the selection of nucleic acids (aptamers) capable of high affinity binding to biomolecules, such as proteins, whether they are bound to nucleic acids in a natural condition or not.

Prior to the selection of a nucleic acid of interest binding to a specific biomolecule (e.g., a protein), securing the specific biomolecule is requisite for conventional SELEX methods. That is, according to conventional SELEX methods, a protein (i.e., the specific biomolecule) capable of binding to a nucleic acid of interest must be first obtained through mass production and purification and then allowed to react with a library of single-stranded nucleic acids, followed by iterative selection and amplification to pick up highly affinitive and specific nucleic acids (aptamers). Hence, conventional nucleic acid selection methods through SELEX do not recognize at all the technical spirit for selecting and utilizing a group of nucleic acids significant for a population of numerous unknown biomolecules within biospecimens.

Profiles of biomolecules including unknown molecules, as found in biospecimens such as tissues, cell aggregates, single cells, microorganisms, etc. are obtained by various methods using physical and chemical properties thereof. For example, biomolecules may be subjected to electrophoresis on the basis of molecular weights or pI values thereof to give a profile which shows quantitative states of the biomolecules in the biospecimen.

Further, a profile may be analyzed to determine useful biomolecules which are then separated and confirmed by MALDI-TOF (Matrix Assisted Laser Desorption/Ionization-Time of Flight). Recently, extensive research has been performed on protein profiles with the aid of SELDI-TOF-MS (Surface-enhanced laser desorption/ionization time of flight mass spectrometry) (Adam et al., Cancer Research, 62, 3609-3614. 2002; Li et al., Clinical Chemistry, 48, 1296-1304. 2002; and Petricoin et al., The Lancet, 359, 572-577. 2002).

Also recently, protein chips and aptamer chips have been developed for high throughput screening of proteinous substances (Smith et al., Mol Cell Protomics, 11-18. 2003; and McCauley et al., Anal Biochem, 319(2), 244-250. 2003).

A protein chip on which different protein molecules, for example, antibodies, have been affixed at separate locations in an ordered manner, can be used to identify and quantify a substance of interest. The most common protein chip is the antibody microarray, where antibodies are spotted onto the protein chip using a microarrayer. Detection methods must sense the signals which are generated at very weak intensities because the protein chip is designed to integrate various antibodies at a high density on a small area so as to provide as much information as possible with one chip. In addition, the integration degree is required to increase as bio information on proteins is expanded, thereby requiring a quantitatively and qualitatively faster and more accurate detection method.

The preferred method of detection currently is laser-induced fluorescence detection, but electrochemical detection is also well developed. As described above, many techniques have been provided for obtaining and analyzing profiles of specific proteins in biospecimens by use of protein chips. However, they suffer from the disadvantage of using an expensive instrument and reagents, performing complicated procedures and being applicable to antigenic molecules only.

In aptamer chips, the same factors as in protein chips are employed with the exception that aptamers (nucleic acids) are used instead of proteins, for example, antibodies.

As mentioned above, the protein chips and the aptamer chips which have been developed so far to disclose quantitative states of biomolecules in biospecimens, that is, to obtain profiles of biomolecules, are disadvantageous in that expensive instruments and reagents are used and complicated procedures are performed thereon. Particularly, the protein chips and the aptamer chips developed thus far are limited to the proteins from which antibodies or aptamers can be prepared.

Although a biospecimen is known to contain millions of proteins therein, only tens of thousands of proteins are identified. Therefore, there is a high need for techniques for obtaining quantitative states, that is, profiles of unknown biomolecules, such as unknown proteins, in biospecimens.

In research into the entirety of biomolecules of a biospecimen, the analysis of the profiles of disease-related biomolecules is useful for the identification of biomolecules which can serve as diagnostic markers, which can monitor therapeutic results, which can play important roles in the outbreak or the progressions of diseases, which is related to disease sensitivity, and which can become drug targets.

### DISCLOSURE OF INVENTION

Therefore, it is an object of the present invention to provide a nucleic acid chip which can obtain binding profiles between unknown biomolecules of a biospecimen and single-stranded nucleic acids, whereby various biologically significant facts including the association between disease information and the unknown biomolecules can be analyzed.

According to the present invention, a nucleic acid chip for obtaining binding profiles between unknown biomolecules and single-stranded nucleic acids, a method for manufacturing the chip, and a method for analyzing the unknown biomolecules using the chip are provided. The nucleic acid chip according to the present invention can be used in the analysis of biological significance of unknown biomolecules in the biospecimen.

The method of manufacture for a nucleic acid chip comprises a first step of reacting a biospecimen containing an unknown biomolecule with random single-stranded nucleic acids having random base sequences to determine biomolecule-binding single stranded nucleic acids capable of binding the unknown biomolecule; and a second step of synthesizing capture single stranded nucleic acids comprising the determined biomolecule-binding single stranded nucleic acids and/or single stranded nucleic acids having base sequences complementary to those of said determined biomolecule-binding single stranded nucleic acids and affixing the capture single stranded nucleic acids on a substrate.

The nucleic acid chip according to the present invention comprises a solid substrate with capture single stranded nucleic acids affixed thereon, said capture single stranded nucleic acids comprising biomolecule-binding single stranded nucleic acids capable of binding the unknown biomolecules and/or single stranded nucleic acids complementary to the biomolecule-binding single stranded nucleic acids.

The method for analyzing an unknown biomolecule in accordance with the present invention comprises the steps of: preparing a nucleic acid chip according to the present invention; reacting single stranded nucleic acids identical in base sequence to the capture single stranded nucleic acids of the nucleic acid chip with the unknown biomolecule to form biomolecule-target single stranded nucleic acid complexes and separating the biomolecule-target single stranded nucleic acid complexes; isolating, amplifying and labeling the target single stranded nucleic acids of the biomolecule-target single stranded nucleic acid complexes; reacting the labeled target single stranded nucleic acids with the capture single stranded nucleic acids of the nucleic acid chip and obtaining a binding profile from a distribution of the labeled target single stranded nucleic acids over the chip; and comparing the profile with pre-existing profile data to analyze biological significance of the unknown biomolecule.

The principle underlying the present invention is that a nucleic acid chip in which capture single stranded nucleic acids complementary to biomolecule-binding single stranded nucleic acids capable of binding unknown biomolecules are affixed on a substrate is used to obtain hybridization profiles between the capture single stranded nucleic acids and the target single stranded nucleic acids which are separated from biomolecule-target single stranded nucleic acid complexes resulting from the association of an unknown biomolecule of interest with the biomolecule-binding single stranded nucleic acids so as to analyze the hybridization properties, that is, the binding profiles between the known biomolecule and the single stranded nucleic acids. Thus, single stranded nucleic acids which are complementary to the single stranded nucleic acids binding to unknown biomolecules are used as the capture single stranded nucleic acids on the chip. However, during the amplification of the target single stranded nucleic acids separated from the biomolecule-target single stranded nucleic acid complexes, the single stranded nucleic acids complementary to the target single stranded nucleic acids binding to the unknown biomolecules are also produced, with information identical or similar to that of the target single stranded nucleic acids retained therein. Thus, the biomolecule-binding single stranded nucleic acids capable of binding with unknown biomolecules may be used as the capture single stranded nucleic acids of the chip, as well. Further, both the biomolecule-binding single stranded nucleic acids and the single stranded nucleic acids complementary to the biomolecule-binding single stranded nucleic acids may be used simultaneously as the capture single stranded nucleic acids.

As a result of the use of the nucleic acid chip of the present invention in the analysis of unknown biomolecules, extensive profile data can be and have been accumulated. From them, specific single stranded nucleic acids which make a great contribution to the analysis of the biological significance of unknown biomolecules within specific biospecimens can be naturally discovered, leading to the excavation of single stranded nucleic acids of biological significance.

Examples of the viable biospecimens include bacteria, fungi, viruses, cells and tissues. The biomolecule to be analyzed for biological significance is selected from a group consisting of proteins, carbohydrates, lipids, hydrocarbonates, polysaccharides, glycoproteins, hormones, receptors, antigens, antibodies, enzymes and combinations thereof.

In the method for manufacturing a nucleic acid chip, the first step is to determine the single stranded nucleic acids capable of binding to an unknown biomolecule (hereinafter referred to as “biomolecule-binding nucleic acids”) by reacting single stranded nucleic acids having random base sequences (hereinafter referred to as “random single stranded nucleic acids”) with the unknown biomolecule.

Preferably, the determination of the biomolecule-binding single stranded nucleic acids may be achieved by: reacting the random single stranded nucleic acids with the unknown biomolecule of the biospecimen to form biomolecule-single stranded nucleic acid complexes; washing the biomolecule-single stranded nucleic acid complexes and selecting complexes in which the single stranded nucleic acids are bound to the biomolecule above a predetermined degree of binding affinity of the single stranded nucleic acids for the biomolecule; separating the single stranded nucleic acids from the selected complexes and amplifying the single stranded nucleic acids; and cloning the amplified single stranded nucleic acids into vectors and determining base sequences of the single stranded nucleic acids.

The selection and amplification of the biomolecule-single stranded nucleic acid complexes may be repeatedly conducted many times. However, since a biospecimen contains numerous biomolecules in very different quantities, a linear process in which many rounds of washing is followed by only one round of selection and amplification may be preferred over a circular process in which the selection and amplification of the biomolecule-binding single stranded nucleic acids is repeatedly conducted.

The random single stranded nucleic acids may be random RNAs which can be prepared by converting single-stranded DNA oligonucleotides having the following random base sequences into double-stranded DNAs, followed by in vitro transcription.

5′-GGGAGAGCGGAAGCGTGCTGGGCC N₄₀
CATAACCCAGAGGTCGATGGATCCCCCC-3′

(Wherein the underlined base sequences are invariable regions and N₄₀ means the presence of the four bases A, G, T and C at equal concentrations at each position)

The FW primer of SEQ ID NO. 1 (5′-GGGGGA ATTCTAATACGACTCACTATAGGGAGAGCGGAAGCGTGCTGGG-3′) for use in PCR (polymerase chain reaction) can hybridize with the 5′-terminal underlined base sequence and contains a promoter base sequence for the RNA polymerase of bacteriophage T7.

On the other hand, the RE primer of SEQ ID NO. 2 (5′-GGGGGGATCCATCGACCTCTGGGTTATG-3′) for use in the PCR can hybridize with the 3′-terminal underlined base sequence.

The biomolecule-binding single-stranded nucleic acids are single-stranded RNAs containing 2′-F-substituted pyrimidines and can be synthesized through in vitro transcription and purified.

A solution containing the synthesized random single-stranded RNA at a concentration of 10¹⁵ base sequences/mL may be reacted with biomolecules for 30 min.

RT-PCR (reverse transcription-PCR) products from the biomolecule-binding single stranded nucleic acids are inserted into vectors to secure individual clones which may be used to determine base sequences of the biomolecule-binding single stranded nucleic acids.

The reaction between single-stranded nucleic acids and biomolecules is conducted at a temperature lower than that for SELEX, and preferably at 20 to 37° C.

Generally, the reaction is conducted in the presence of excessive proteins and single stranded nucleic acids to prevent the non-specific binding of the biomolecule-binding single stranded nucleic acids. Preferably, yeast tRNA, salmon sperm DNA, or human placental DNA may be used for this purpose.

In the method of manufacturing a nucleic acid chip, the second step is to affix the determined biomolecule-binding single stranded nucleic acids and/or capture single stranded nucleic acids on a substrate, the capture single stranded nucleic acids having base sequences complementary to those of the determined biomolecule-binding single stranded nucleic acids.

Because the capture single-stranded nucleic acids serve as an essential factor which has a great influence on the hybridization, it is very important to determine the base sequences thereof. Individual capture single-stranded nucleic acids which are affixed on the chip of the present invention consist of unique base sequences, and hybrids between the capture single-stranded nucleic acids and the target single stranded nucleic acids must maintain suitable Tm values. Accordingly, the degree of hybridization of the hybrids must be enough so that they can maintain signals without contamination with fluorescent-labeled target single stranded nucleic acids.

Therefore, the base sequences of the capture single stranded nucleic acids are determined on the basis of those of the biomolecule-binding single stranded nucleic acids selected from the random single stranded nucleic acids of the first step. Preferably, the capture single stranded nucleic acids are oligonucleotides which have a base sequence of 16 bp-60 bp.

The substrate of the nucleic acid chip may be formed of an inorganic substance such as glass or silicon or polymeric substances such as acrylates, PET (polyethylene terephtalate), polycarbonate, polystyrene or polypropylene and is preferably a glass slide. The substrate may be coated with amine or aldehyde groups. For example, the capture single-stranded nucleic acids may be affixed in an ordered manner on a GAPS (Gamma Amino Propyl Silane)-coated slide, e.g., an UltraGAPSTM-coated slide (Corning), to manufacture a nucleic acid chip.

For the manufacture of the nucleic acid chip according to the present invention, a microarrayer system may be used. In this regard, individual capture single-stranded nucleic acids are dissolved in a controlled concentration in buffer. At this time, a humidity of 70%-80% is maintained inside the arrayer system while spotting is performed. After being incubated in a humidified chamber, the spotted slides are baked in a UV crosslinker.

Following the fixation of the capture single stranded nucleic acids on the glass slide, the slide is dried by centrifugation and stored in a light-free environment until use.

Chips over which the capture single stranded nucleic acids are distributed in an order array can be manufactured using a well-known method (M. schena; DNA microarray; a practical approach, Oxford, 1999).

As long as the nucleic chip can analyze the biological significance of an unknown biomolecule with accuracy, it is advantageous in terms of manufacture cost and analysis efficiency to reduce the number of the capture single stranded nucleic acids affixed on the chip.

For this reason, the method for manufacturing a nucleic chip in accordance with the present invention may further comprise the steps of analyzing the degree of contribution of individual capture single stranded nucleic acids to the biological significance of an unknown biomolecule and selecting the capture single stranded nucleic acids on the basis of the degree of contribution to the biological significance of unknown biomolecules to reduce the number of the capture single stranded nucleic acids to be affixed on the chip.

### ADVANTAGEOUS EFFECTS

On the basis of high throughput screening of proteinous substances, the nucleic chip and the analysis method in accordance with the present invention are very simple and efficient and analysis incurs only a low cost. With the ability to obtain profiles of unknown biomolecules of biospecimens including microorganisms, viruses, cells and tissues, the chip and the method may be used as means for analyzing biological significance of unknown biomolecules in various fields including medicine, veterinary science, environmental engineering, food engineering, agriculture and the like.

During the analysis of unknown biomolecules for biological significances, the nucleic chip and the analysis method in accordance with the present invention can not only detect biological functions of the unknown biomolecules and determine the structures of the biomolecules, but also can select single stranded nucleic acids specific for binding with the biomolecules. Thus, the chip and the analysis method can be used as a means for accurately understanding the functions of the biomolecules using the selected single stranded nucleic acids.

In research into the gamut of biomolecules of a biospecimen, the analysis of the profiles of disease-related biomolecules is useful and effective for the identification of biomolecules which can serve as diagnostic markers, allow monitoring of therapeutic results, play important roles in the outbreak or the progressions of diseases, exhibit sensitivity for specific diseases, and which can become drug targets.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a process of determining biomolecule-binding single stranded nucleic acids essential for the manufacture of a nucleic chip according to the present invention,

FIG. 2 is a view schematically illustrating a process of obtaining binding profiles between unknown biomolecules and single stranded nucleic acids on a nucleic acid chip according to the present invention,

FIG. 3 shows serum profiles of an (A) healthy person and a (B) stable angina pectoris patient, obtained by use of a nucleic acid chip according to the present invention,

FIG. 4 is an illustration of a flow process for constructing a database of the profiles obtained by use of the nucleic chips of the present invention using the blood of patients and classified according to diseases,

FIG. 5 is an illustration of a flow process for diagnosing a disease of a person by use of the profile database constructed according to disease classification and using an artificial neural network algorithm,

FIG. 6 is a view illustrating a result obtained after the diagnosis of a cardiovascular disease was conducted by using a database of the human serum protein profiles obtained by use of nucleic acid chips according to the present invention, and using an artificial neural network algorithm,

FIG. 7 is a view illustrating a result obtained after the diagnosis of liver cancer was conducted using a database of the human serum protein profiles obtained by use of nucleic acid chips according to the present invention, and using an artificial neural network algorithm,

FIG. 8 is a view illustrating a result obtained after the metastasis of liver cancer was analyzed using a database of the human serum protein profiles obtained by use of nucleic acid chips according to the present invention, and using an artificial neural network algorithm,

FIG. 9 is an illustration showing a flow process for identifying a biomolecule characteristic of patients suffering from cardiovascular diseases, using a database of the human serum protein profiles obtained by the use of nucleic acid chips according to the present invention,

FIG. 10 a spectrum of a protein which is identified as being characteristically present in the sera of patients suffering from myocardial infarction, the identification being performed using a database of human serum protein profiles obtained by use of nucleic acid chips according to the present invention, showing the amino acid sequence of the protein,

FIG. 11 is a view showing the binding to the lung carcinoma cell line NCI-H1299 of a single stranded nucleic acid selected through the analysis of the profiles obtained by use of a nucleic acid chip according to the present invention,

FIG. 12 is a view showing the specificity for E. coli KCTC12006 and Salmonella typhimurium ATCC13311 of a biomolecule-binding single stranded nucleic acid selected through the analysis of profiles of biomolecules present on the surfaces of E. coli and Salmonella, and

FIG. 13 is a view showing the use of biomolecule-binding single stranded nucleic acids, identified as being specific for E. coli by the nucleic acid chip of the present invention, along with gold nano-particles, to be used in the qualitative and quantitative assay of food for contamination with E. coli.

### BEST MODE FOR CARRYING OUT THE INVENTION

Reference now should be made to the drawings in order to describe a nucleic acid chip, a method for manufacturing the nucleic chip, and a method for analyzing unknown biomolecules using the chip.

A better understanding of the present invention may be obtained through the following examples which are set forth to illustrate, but are not to be construed as the limit of the present invention.

### Example 1

### Preparation of Single-Stranded Nucleic Acid Binding to Human Serum Protein

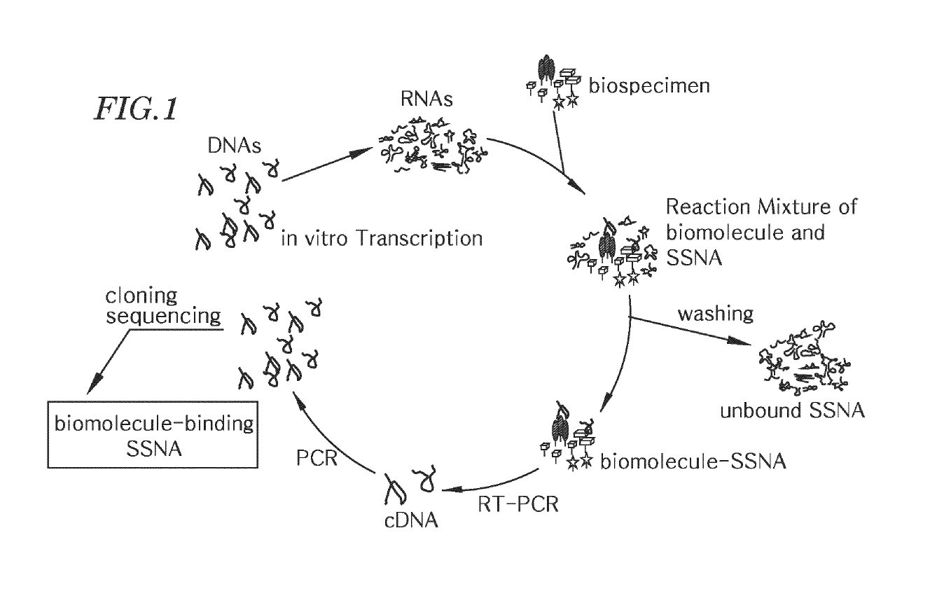

As schematically illustrated in FIG. 1, PCR (Polymerase Chain Reaction) was performed with single-stranded DNAs of the following random base sequence to produce double-stranded DNAs, followed by in vitro transcription of the double-stranded DNAs to form a single-stranded RNA library (random single-stranded nucleic acids).

5′-GGGAGAGCGGAAGCGTGCTGGGCC N₄₀
CATAACCCAGAGGTCGATGGATCCCCCC-3′

(Wherein, the underlined base sequences are invariable regions and N₄₀ means the presence of the four bases A, G, T and C at equal concentrations for each position)

The FW primer of SEQ ID NO. 1 for use in this PCR can hybridize with the 5′-terminal underlined base sequence and contains a promoter base sequence for the RNA polymerase of bacteriophage T7.

On the other hand, the RE primer of SEQ ID NO. 2 for use in the PCR can hybridize with the 3′-terminal underlined base sequence. The FW primer and the RE primer contain the restriction sites EcoRI and BamHI, respectively, for subsequent cloning.

The random single-stranded nucleic acids to be reacted with biomolecules constitute an RNA library containing 2′-F-substituted pyrimidines. It was prepared by converting the single-stranded DNA library transcripts into double-stranded DNA library transcripts through PCR in the presence of the PCR primers, followed by in vitro transcription.

PCR was performed in the presence of 2,500 pmoles of a pair of PCR primers (5P7) in a buffer solution containing 50 mM KCl, 10 mM Tris-Cl (pH 8.3), 3 mM MgCl₂, 0.5 mM dNTP (DATP, dCTP, dGTP, and dTTP) and 0.1 U Taq DNA Polymerase (Perkin-Elmer, Foster City Calif.), with 1,000 pmoles of single-stranded nucleic acid transcripts serving as templates, followed by purification of the PCR product through QIAquick-spin PCR columns (QIAGEN Inc., Chatsworth Calif.).

Random single-stranded RNA containing 2′-F-substituted pyrimidines was synthesized through in vitro transcription of the double-stranded DNA, and purified. In this regard, 200 pmoles double-stranded DNA transcripts, 40 mM Tris-Cl (pH 8.0), 12 mM MgCl₂, 5 mM DTT, 1 mM spermidine, 0.002% Triton X-100, 4% PEG 8000, 5 U T7 RNA Polymerase, ATP and GTP, each 1 mM, and 2′F-CTP and 2′F-UTP, each 3 mM, were reacted at 37° C. for 6˜12 hours, followed by purification through a Bio-Spin 6 chromatography column (Bio-Rad Laboratories, Hercules Calif.). The random single-stranded RNA thus obtained was analyzed for quantity and purity using a UV spectrometer.

A solution containing the synthesized random single-stranded RNA at a concentration of 10¹⁵ base sequences/mL was added in an amount of 200 μmol/200 μL to a selection buffer (50 mM Tris·Cl (pH 7.4), 5 mM KCl, 100 mM NaCl, 1 mM MgCl₂, 0.1% NaN₃), heated at 80° C. for 10 min, and allowed to stand on ice for 10 min. To this was added yeast tRNA (Life Technologies) in an amount five times as much as the used single-stranded nucleic acids, along with 0.2% BSA (bovine serum albumin, Merck), to prepare a reaction solution.

A nitrocellulose membrane disc was soaked in a mixture of 10 μL of a serum sample and 90 μL of PBS for 30 min with shaking. The resulting serum sample-attached disc was treated with the single-stranded RNA for 30 min.

Single-stranded RNAs capable of binding to human serum samples (biomolecules) are primary targets of selection. After reaction between the single-stranded RNAs and the human serum sample, washing processes were repeated with various washing buffers so that human serum-protein (biomolecule)-single stranded RNA complexes could be secured by a single selection process.

0˜1× SELEX buffer or 0˜500 mM EDTA buffer was used as a washing buffer for biomolecule-single-stranded RNA complexes. RT-PCR was performed with the isolated complexes to prepare a DNA pool which directs serum protein binding RNAs (biomolecule-binding single stranded nucleic acids). In this regard, the selection and amplification procedure may be repeated to construct biomolecule-binding single stranded RNAs.

Thereafter, the RT-PCR product DNA thus obtained was cloned into plasmids to secure individual clones. The plasmids were isolated and used to determine base sequences of the biomolecule-binding single stranded nucleic acids according to a standard method.

The base sequences of capture single-stranded nucleic acids to be used in the nucleic acid chips for obtaining profiles of biomolecules in accordance with the present invention are complementary to those of the single-stranded nucleic acids binding to human serum proteins or the biomolecule-binding single stranded RNAs. Thus, the capture single-stranded nucleic acids could be determined by selecting biomolecule-binding single stranded RNAs having the most stable secondary structures after the secondary structures of biomolecule-binding single stranded RNAs and the free energies of the secondary structures were obtained with the aid of a MFOLD program for modeling secondary structures of nucleic acids.

### Example 2

### Manufacture of a Nucleic Acid Chip

Capture single-stranded nucleic acids to be affixed on a glass slide were chemically synthesized as single-stranded nucleic acids (oligonucleotides) the base sequences of which were complementary to those of the approximately 3,000 biomolecule-binding single stranded RNAs determined in Example 1 (Bioneer, Korea).

The capture single-stranded nucleic acids were affixed in an ordered manner on a GAPS (Gamma Amino Propyl Silane)-coated slide, for example, a UltraGAPS™-coated slide (Corning) to manufacture a nucleic acid chip. For the manufacture of nucleic acid chips, a microarrayer system operating in a pin type (GenPak) was used while the spot spacing of the arrays was set to be 370 μm center-to-center. Individual capture single-stranded nucleic acids were dissolved at a controlled concentration in standard solutions. A humidity of 70% was maintained inside the arrayer system while it performed spotting. After being incubated for 24˜48 hours in humidified chambers, the spotted slides were baked in a UV crosslinker. Following such fixation, the slides were dried by centrifugation and stored in a light-tight place.

### Example 3

### Preparation of Human Serum Protein (Biomolecule)-Targeted Single Stranded Nucleic Acid Complex and Target Single Stranded Nucleic Acid

The plasmids prepared in Example 1 to carry the biomolecule-binding single stranded nucleic acids used in the manufacture of the nucleic acid chips were mixed in equal molar amounts to prepare a plasmid pool from which a pool of single-stranded RNA capable of binding to biomolecules including unknown molecules could be transcribed. A pool of the single-stranded RNAs capable of binding to human serum proteins was prepared from the plasmid pool through PCR using chemically synthesized PCR primers, followed by in-vitro transcription.

PCR was performed with 30 cycles of 30 sec at 94° C., 30 sec at 52° C. and 20 sec at 72° C. using 1 pg of the plasmid pool in a PCR buffer containing 100 μM of 5′-primers, 100 μM of 3′-primers and a dNTP mix (5 mM DATP, 5 mM CTP, 5 mM dGTP, 5 mM dTTP) to synthesize double-stranded DNAs which were then purified through a QIAquick-spin PCR column (QIAGEN Inc., Chatsworth Calif.).

The target single stranded RNAs containing 2′-F-substitute pyrimidines were synthesized by in vitro transcription and purified.

For this in vitro transcription, 200 pmoles the double-stranded DNA products, 40 mM Tris-Cl (pH 8.0), 12 mM MgCl₂, 5 mM DTT, 1 mM spermidine, 0.002% Triton X-100, 4% PEG 8000, 5 U T7 RNA Polymerase, ATP and GTP, each 1 mM, and 2′F-CTP and 2′F-UTP, each 3 mM, were reacted at 37° C. for 6˜12 hours, followed by the purification of the transcripts through a Bio-Spin 6 chromatography column (Bio-Rad Laboratories, Hercules Calif.).

Human sera taken from a healthy person and a patient with stable angina pectoris were used as assay specimens. To 90 μL of PBS buffer was added 10 μL of a serum sample and a nitrocellulose membrane disc was soaked in the mixture for 30 min with shaking. Subsequently, 100˜400 ng of the target single-stranded RNAs prepared above was added to the mixture and incubated for 30 min to form biomolecule-target single stranded RNA complexes.

After the treatment of the serum sample attached disc with the prepared single-stranded RNAs for 30 min, it was washed three times with a selection buffer or 50 mM EDTA to remove unbound RNAs.

The disc to which serum protein (biomolecule)-target single stranded RNA complexes were attached was treated in an RT-PCR buffer before RT-PCR was performed using a Cy-5 labeled primer (5′-Cy5-CGGAAGCGTGCTGGGCC-3′: SEQ ID NO. 3). The target single stranded RNAs prepared from the plasmid pool were subjected to RT-PCR in the same manner using a Cy-3 labeled primer (5′-Cy3-CGGAAGCGTGCTGGGCC-3′). The resulting two solutions were mixed in equal volumes to prepare target single-stranded nucleic acids.

### Example 4

### Reaction of Nucleic Acid Chip with Target Single-Stranded Nucleic Acids

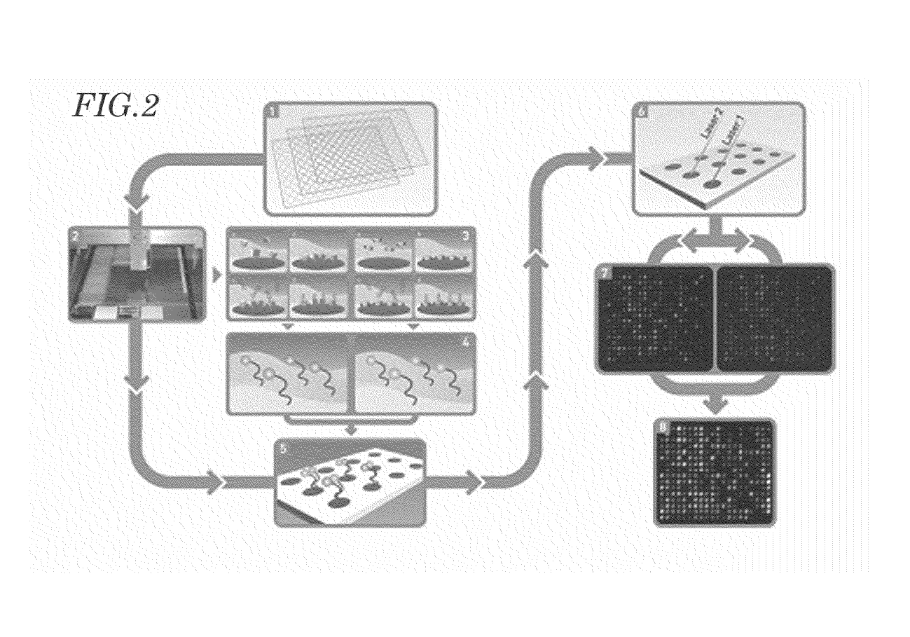

As shown in FIG. 2, the capture single stranded nucleic acids arrayed on the chip were incubated at 60° C. for 4˜12 hours with the target single-stranded RNAs prepared in Example 3 to form pre-hybrids, followed by washing at 42° C. with 0.1×SSC buffer. A hybridization solution containing 1 M NaCl, 0.3 M sodium citrate, 0.5% SDS or 100 μg/ml salmon sperm DNA, 0.2% bovine serum albumin or single-stranded nucleic acids.

After completion of the pre-hybridization, the glass slide was treated at 42° C. for 12 hours with the solution prepared in Example 3 to conduct hybridization, followed by washing the chip with washing solutions. With regard to the washing of the chip, 1×SSC+0.2% SDS, 1×SSC+0.2% SDS, 0.5×SSC+0.2% SDS, and 0.01×SSC+0.2% SDS were used in that order at 42° C. for 30 min for each solution.

### Example 5

### Search and Analysis of Spots on Chip

After completion of the washing in Example 4, the glass slide was dried by centrifugation and scanned with a GenePix4000 laser scanner (Axon Foster City, Calif.). Laser light of a wavelength at 635 nm was used to excite the fluorescent dye (Cy5). Fluorescent images were captured as multi-image-tagged image file format and analyzed with GenePix Pro 3.0 software (Axon).

Signal intensity per spot (unit: quanta) was used for the extract of the signal intensity data. Background signals were subtracted from each corresponding intensity spot. Herein, the term “background signal” means the signal of a local background consisting of four spots neighboring a specific spot.

Generally, spot pixel intensity is considered useful as data when more than 90% thereof exceeds background signal+2 standard deviations (S. D.); otherwise, it is not used for data analysis.

Signal intensity is normalized against variations according to labeling efficiency using internal standard (IS) intensity (e.g., Normalized Intensity=Probe Intensity/IS intensity). In the case of monolabeling, the signal intensity of Cy5 channels is recorded. When spotting is conducted two or more times, mean values are used. For the signal intensity (S) of target single stranded nucleic acids, a median value of individual spot pixel intensities (median value of pixel-by-pixel) is used. The signal intensity (S) is normalized against variations according to labeling efficiency using internal standard (IS) signals.

S′(normalized value)=S(Cy5-reference)×(Cy5-IS).

Using this process, relationships between analysis results of pixel density and actual sample amounts are found to determine the correlation therebetween. A method may be provided for representing a profile of a biomolecule in a spot pattern by converting the fluorescent data of the nucleic acid chip into image data. Spot patterns may be analyzed using algorithms such as hierarchical clustering and artificial neural networks.

The fluorescent intensities of spots may vary depending on the properties of the double strands formed between the capture single-stranded nucleic acids and the target single-stranded nucleic acids. The binding intensity and amount of the human serum protein-(target) single stranded nucleic acid complex is determined by specificity and binding affinity therebetween.

While the base sequences of the target single-stranded nucleic acids originating from the human serum protein-target single stranded nucleic acid and of the capture single-stranded nucleic acids affixed on the chip determine the stability of the double strands between the target single stranded nucleic acids and the capture single stranded nucleic acids, the amount of the target single stranded nucleic acids on the chip has an influence on the fluorescent intensity.

That is, the fluorescent intensity represents the amount of the target single stranded nucleic acids and the amount of the target single stranded nucleic acid expresses the amount of the human serum protein-target single stranded nucleic acid complexes, which in turn reflects the amount of the biomolecules present in a biospecimen. Thus, the amount of a specific, unknown biomolecule in a biospecimen can be determined from the fluorescent intensity of the spots corresponding to the biomolecule. As a result, the spot patterns determined through the analysis of the fluorescent intensities of spots provide profiles of human serum proteins.

Color spectra of blue-yellow-red given to the spots are determined by the ratio between the Cy-3-labeled target single stranded nucleic acids and the Cy-5-labeled target single stranded nucleic acids, both being hybridized with the capture single stranded nucleic acids on the chip. Because the color intensity detected at a specific spot represents the amount of a specific biomolecule (protein) present in the human serum specimen, the image data formed from the color spectra of all spots on the nucleic chip provide profiles of the biomolecules present in the biospecimen.

In more detail, the target single stranded nucleic acids which hybridize with the capture single stranded nucleic acids to form double stranded nucleic acids at a specific spot consist of Cy-3 labeled target single stranded nucleic acids and Cy-5 labeled target single stranded nucleic acids. The former is present in a constant quantity while the amount of the latter is proportional to that of a biomolecule of interest in a human serum. Accordingly, a specific spot appears blue when Cy-5 labeled single stranded nucleic acids are present in a relatively small amount, yellow when Cy-5 and Cy-3 are present in an equal amount, and red when Cy-5 labeled single stranded nucleic acids are present in a relatively large amount.

The fluorescent intensity of spots on the nucleic acid chip varies depending on the number of the target single stranded nucleic acids within the double stranded nucleic acids, which is correlated with the number of the biomolecules. Hence, the image data expressing the color spectra of all spots on the nucleic acid chip of the present invention can provide profiles for all biomolecules of a biospecimen including unknown biomolecules.

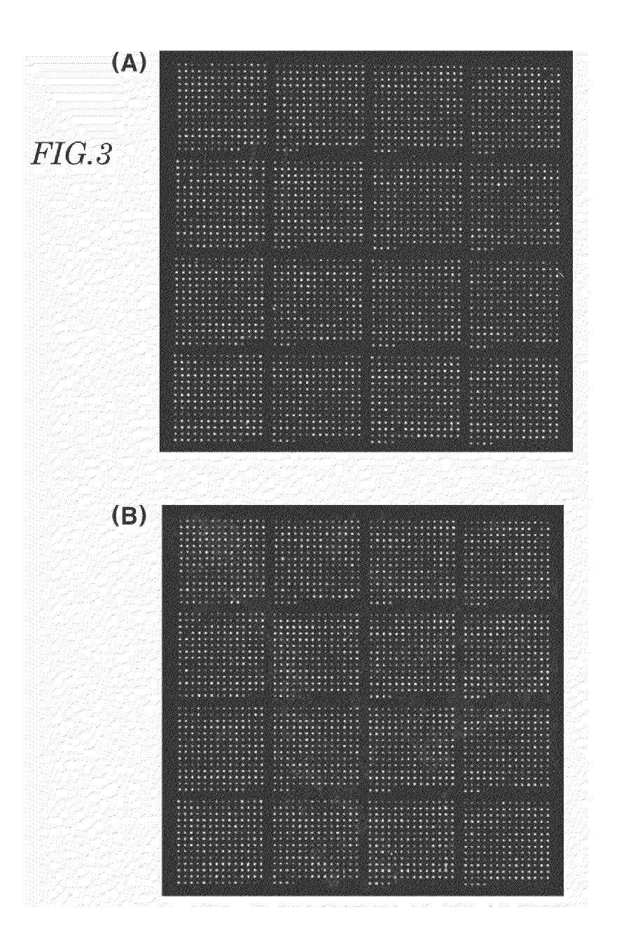

The test results are shown in FIG. 3. The glass slides, as seen in FIG. 3, show spectra of blue-yellow-red colors at various fluorescent intensities at spots onto which the capture single stranded nucleic acids, based on the target single stranded nucleic acids capable of binding to serum proteins, are affixed.

As is apparent from the data of FIG. 3, the nucleic acid chips based on target single stranded nucleic acids capable of binding to human serum proteins in accordance with the present invention can give profiles of the human serum proteins, which differ between a healthy person (A) and a patient suffering from stable angina pectoris.

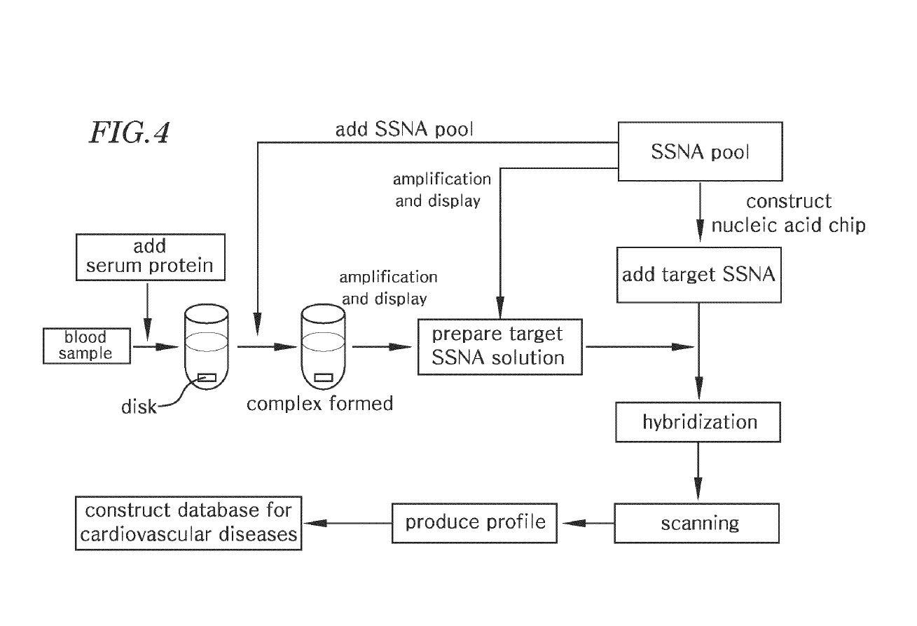

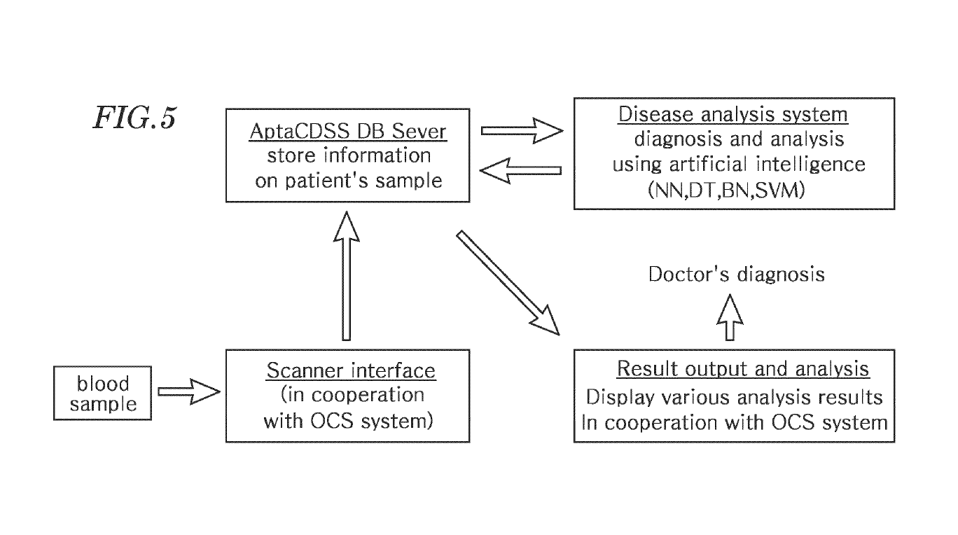

FIG. 4 is an illustration of a flow process for constructing a database of the profiles obtained by use of the nucleic chips of the present invention using blood samples of patients with different types of disease. FIG. 5 is an illustration of a flow process for diagnosing the disease of a person by use of the profile database constructed according to disease type and an artificial neural network algorithm.

As illustrated in FIG. 4, the database constructed with the profiles obtained from various biospecimens can be analyzed and effectively used for gathering bioinformatic data.

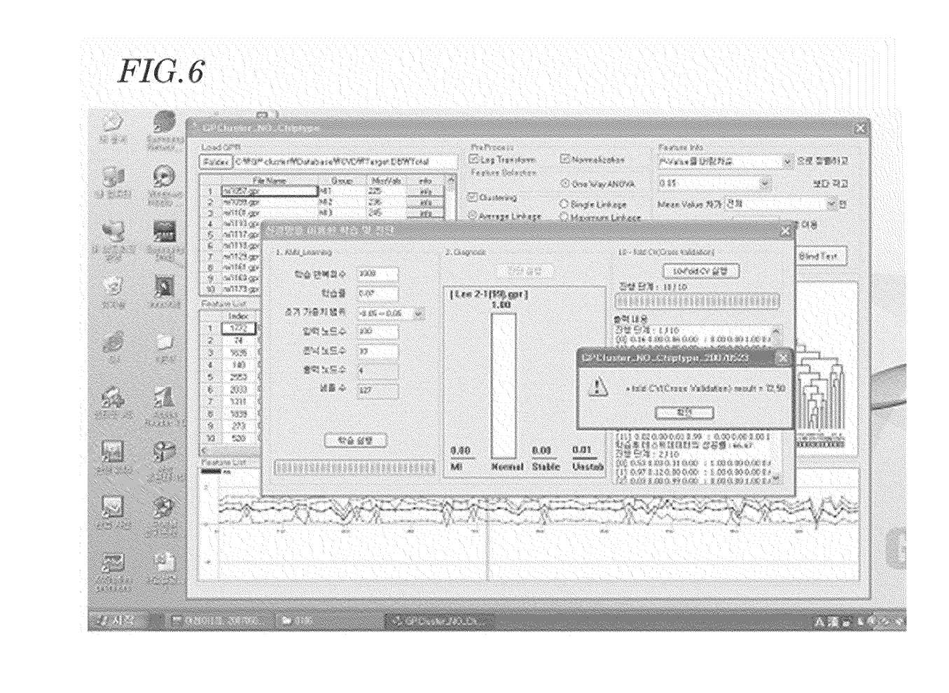

A serum sample from the person Lee 2-1 (99) was assayed using the serum profile databases of healthy persons and patients suffering from cardiovascular diseases including stable angina pectoris, unstable angina pectoris and myocardial infarction and the results are given in FIG. 6. The subject was found to be healthy as he showed 72.5% 10 fold cross validation.

Clinical data of the serum samples used to construct databases for diagnosing cardiovascular diseases are summarized in Table 1, below, and the samples were obtained from 127 persons including 37 healthy persons, 36 stable angina pectoris patients, 27 unstable angina pectoris and 27 myocardial infarction patients.

TABLE 1
Clinical Information of Patients with Cardiovascular Diseases

| | | | | Unstable | |
|---|---|---|---|---|---|
| | | | Stable Angina | Angina | Myocardial |
| | | Healthy | pectoris | pectoris | Infarction |
| Gender | Male | 35 | 35 | 27 | 27 |
| | Female | 2 | 1 | 1 | 0 |
| Age | 40-49 | 1 | 0 | 1 | 0 |
| | 50-59 | 13 | 17 | 15 | 17 |
| | 60-69 | 22 | 18 | 11 | 10 |
| | 70-79 | 1 | 1 | 1 | 0 |
| Total | | 37 | 36 | 28 | 27 |

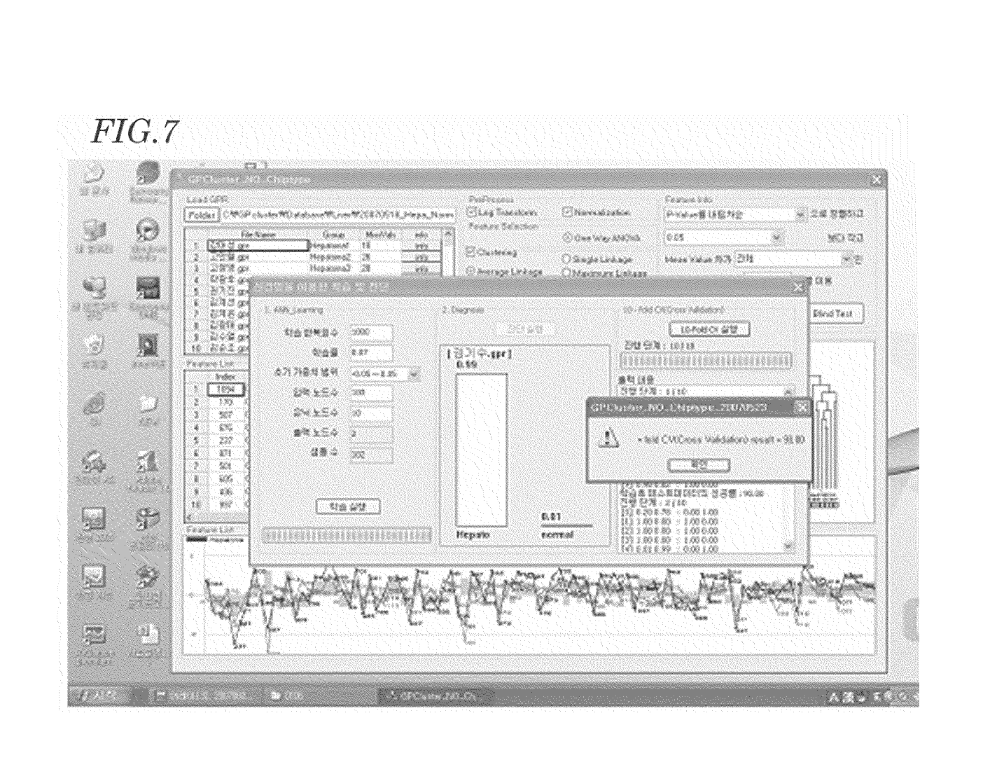

A serum sample from the person named Kim was assayed using the serum profile databases of healthy persons and liver cancer patients and the results are given in FIG. 7. The subject was found to be afflicted with liver cancer as it showed 93.0% 10 fold cross validation.

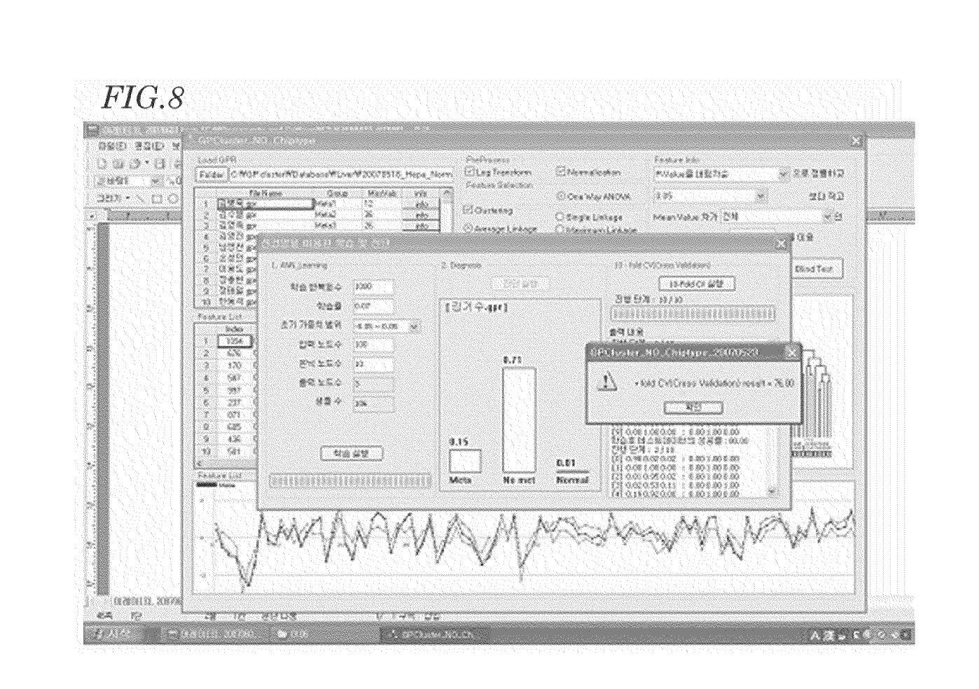

To determine whether the cancer underwent metastasis, the serum sample was further assayed using serum profile databases of healthy persons, metastatic and non-metastatic liver cancer patients. The results are shown in FIG. 8. The liver cancer was found not to have undergone any metastasis as it showed 76.0% 10 fold cross validation.

Clinical data of the serum samples used to construct databases for diagnosing liver cancer are summarized in Table 2, below, and the samples were obtained from 102 persons including 19 healthy persons and 83 liver cancer patients, of which 72 were non-metastatic liver cancer patients and 11 were metastatic liver cancer patients.

TABLE 2
Clinical Information of Patients with Liver Cancer

| | | Healthy | Metastatic | Non-Metastatic |
|---|---|---|---|---|
| Gender | Male | 17 | 67 | 10 |
| | Female | 2 | 5 | 0 |
| Age | 40-49 | 14 | 60 | 7 |
| | 50-59 | 5 | 7 | 3 |
| | 60-69 | 0 | 5 | 1 |

| | | | |
|---|---|---|---|
| Total | 19 | 72 | 11 |

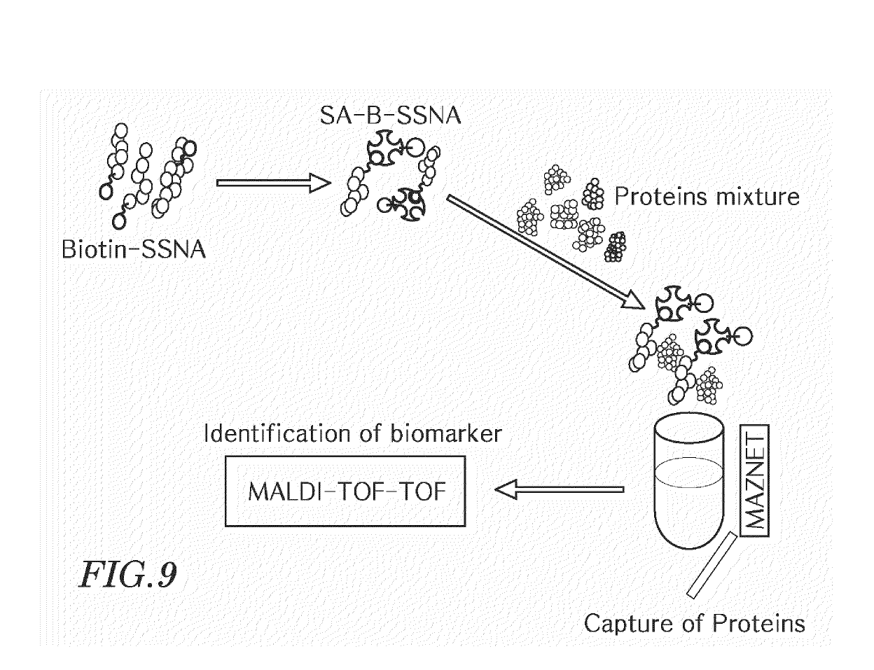

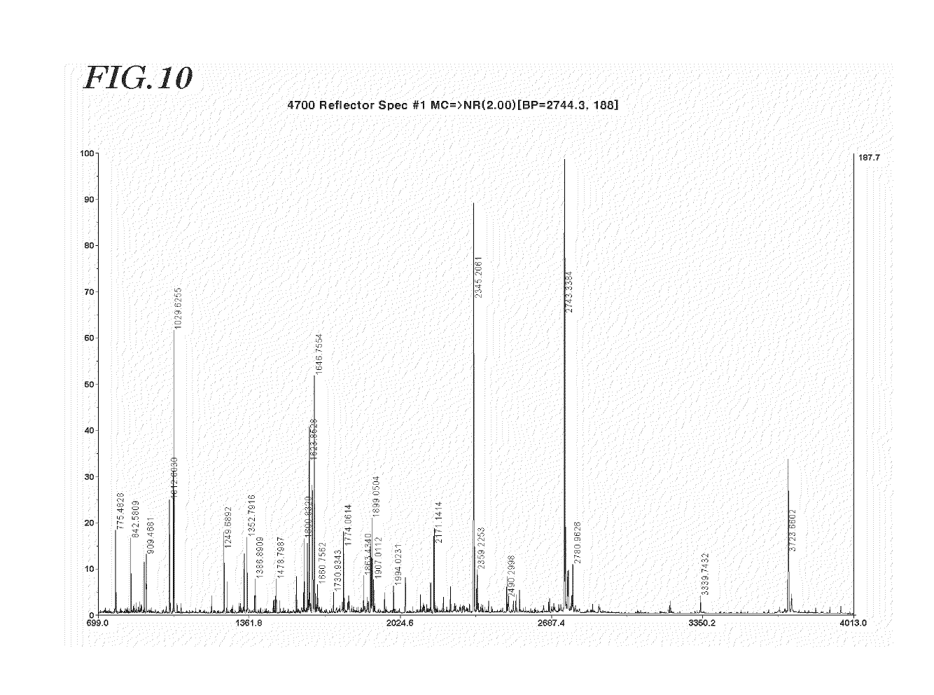

With reference to FIG. 9, an illustration is provided for a flow process for identifying biomolecular characteristics of patients suffering from cardiovascular diseases. After spots peculiar to cardiovascular disease patients are determined by comparison between serum profiles of healthy persons and the patients, as seen in the illustration, corresponding single-stranded nucleic acids are conjugated with biotin and reacted with streptavidin and then with the serum sample to separate the resulting complexes, followed by electrophoretic separation. The bands thus separated are isolated to identify the biomolecule. FIG. 10 is a MALDI-TOF-TOF spectrum of the protein bound to the selected single stranded nucleic acid, showing the amino acid sequence of the protein.

As described above, the nucleic acid chip on which single-stranded nucleic acids derived from on the single-stranded nucleic acids capable of binding to biomolecules are affixed in accordance with the present invention can be applied to the search and analysis of marker biomolecules of a specific biospecimen.

In addition, after a database is constructed from medicinally useful biomarkers, a serum profile of a person of interest is obtained and may be assayed against the database using an artificial neural network algorithm to determine, for example, whether the person is afflicted or not with a cardiovascular disease or liver cancer and, if so afflicted, to determine what the cardiovascular disease is or whether the liver cancer has metastasized.

Comparison with databases constructed per disease type allows the determination of spots peculiar to specific diseases, and the detection of single stranded nucleic acids corresponding to the spots is used to identify proteins which can serve as markers for the diseases.

### Example 6

### Obtainment and Application of a Profile of Cell Surface Biomolecule

6-1. Manufacture of Nucleic Acid Chip

A nucleic acid chip for obtaining profiles of surface biomolecules of the human lung carcinoma cell line NCI-H1299 was manufactured by the process described in Examples 1 and 2. After the incubation of the carcinoma cells with the prepared random single stranded nucleic acids, the cells were washed with wash buffer to remove unbound or weakly bound single stranded nucleic acids therefrom, thus leaving cell (biomolecule)-single stranded nucleic acid complexes, which were centrifuged at 5,000×g to separate the cell-single stranded nucleic acid complexes. These processes were repeated to isolated single stranded nucleic acids capable of binding to surface biomolecules of lung carcinoma cells.

Clones were prepared from the isolated single stranded nucleic acids and base sequenced. From them, approximately 1,000 single stranded nucleic acids capable of binding to surface biomolecules were selected. Oligonucleotides (capture single stranded nucleic acids) complementary to the approximately 1,000 biomolecule-binding single stranded nucleic acids were synthesized as described in Example 2 and affixed on a solid substrate to manufacture a nucleic acid chip in accordance with the present invention.

6-2. Obtainment of Profiles of Cell Surface Biomolecules

Using the nucleic acid chip manufactured in Example 6-1, profiles of the biomolecules present on the surface of the human lung carcinoma cell line NCI-H1299 were obtained. After the treatment of the lung carcinoma cells with a pool of single stranded nucleic acids, the resulting biomolecule-single stranded nucleic acid complexes were washed and separated. The single stranded nucleic acids of the complexes were amplified and labeled in the manner described in Example 3. Capture single stranded nucleic acids were allowed to hybridize with the labeled target single stranded nucleic acids in the manner of Example 4. The quantitative analysis of the label bound to the target single stranded nucleic acids was performed in the manner of Example 5, obtaining profiles of the biomolecules present on the surface of the lung carcinoma cell line.

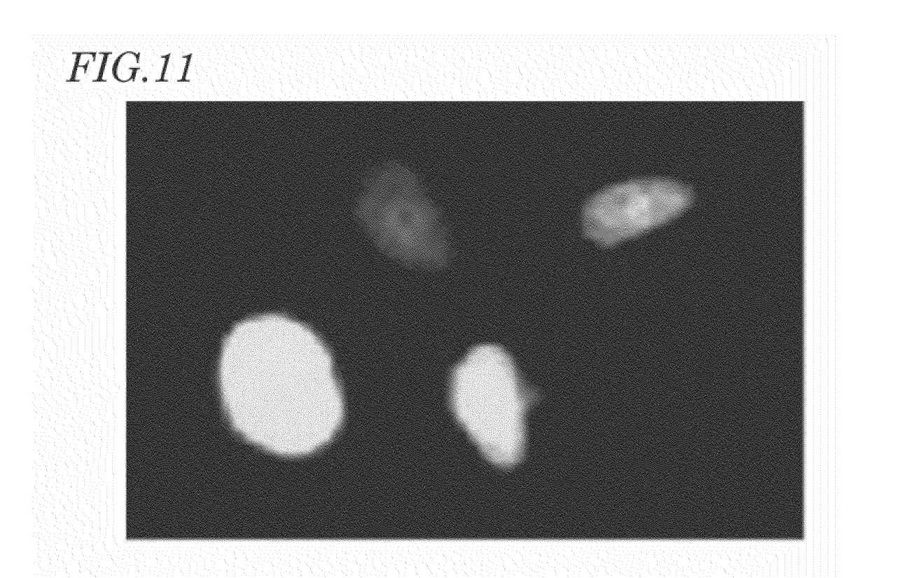

On the basis of the obtained profiles, putative single stranded nucleic acids capable of potentially binding to the lung carcinoma cell line were selected. They were conjugated with FITC and incubated with the lung carcinoma cells before fluorescence scanning. Fluorescent images are shown in FIG. 11.

As seen in this figure, the putative single stranded nucleic acids selected through the analysis of the profiles obtained using the nucleic acid chip of the present invention are found to bind to the lung carcinoma cell line.

### Example 7

### Obtainment and Application of a Profile of Biomolecules on the Surface of E. coli

7-1. Manufacture of Nucleic Acid Chip

A nucleic acid chip according to the present invention for obtaining profiles of the surface biomolecules of E. coli KCTC12006 was manufactured using the process described in Examples 1 and 2.

After the incubation of the E. coli cells with the prepared random single stranded nucleic acids, the cells were washed with wash buffer to remove unbound or weakly bound single stranded nucleic acids therefrom, thus leaving cell (biomolecule)-single stranded nucleic acid complexes, and the cell-single stranded nucleic acid complexes were separated by centrifugation at 5,000×g. These processes were repeated to isolated single stranded nucleic acids capable of binding to surface biomolecules of the E. coli cell.

Clones were prepared from the isolated single stranded nucleic acids and base sequenced. From them, approximately 1,000 single stranded nucleic acids capable of binding to surface biomolecules were selected. Oligonucleotides (capture single stranded nucleic acids) complementary to the approximately 1,000 biomolecule-binding single stranded nucleic acids were synthesized as described in Example 1 and affixed on a solid substrate to manufacture a nucleic acid chip in accordance with the present invention.

7-2. Obtainment of Profiles of Biomolecules Present on the Surface of E. coli

Using the nucleic acid chip manufactured in Example 7-1, profiles of the biomolecules present on the surface of E. coli KCTC12006 were obtained. After the treatment of the E. coli cells with a pool of single stranded nucleic acids, the resulting biomolecule-single stranded nucleic acid complexes were washed and separated. The single stranded nucleic acids of the complexes were amplified and labeled in the manner described in Example 3. Capture single stranded nucleic acids were allowed to hybridize with the labeled target single stranded nucleic acids in the manner of Example 4. The quantitative analysis of the label bound to the target single stranded nucleic acids was performed in the manner of Example 5, obtaining profiles of the biomolecules present on the surface of the E. coli cell.

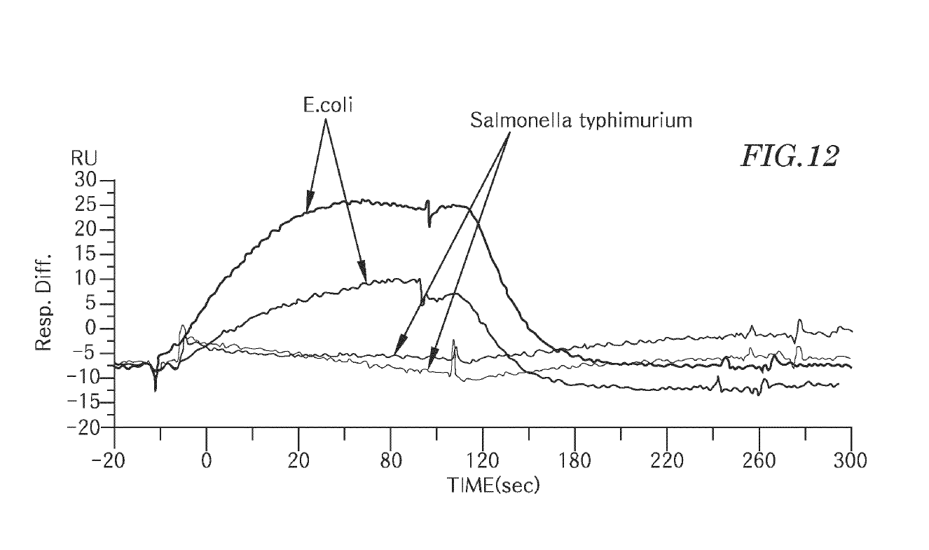

Profiles of biomolecules present on the surface of Salmonella typhimurium ATCC13311 were obtained in the same manner as was the E. coli KCTC12006 to construct a database therefor. Using a hierarchical clustering method, single stranded nucleic acids capable of binding to E. coli were selected. These single stranded nucleic acids were analyzed for specificity using an SPR device (BIAcore) and the results are given in FIG. 12. As shown, the single stranded nucleic acids were found to have greater specificity for E. coli than for Salmonella.

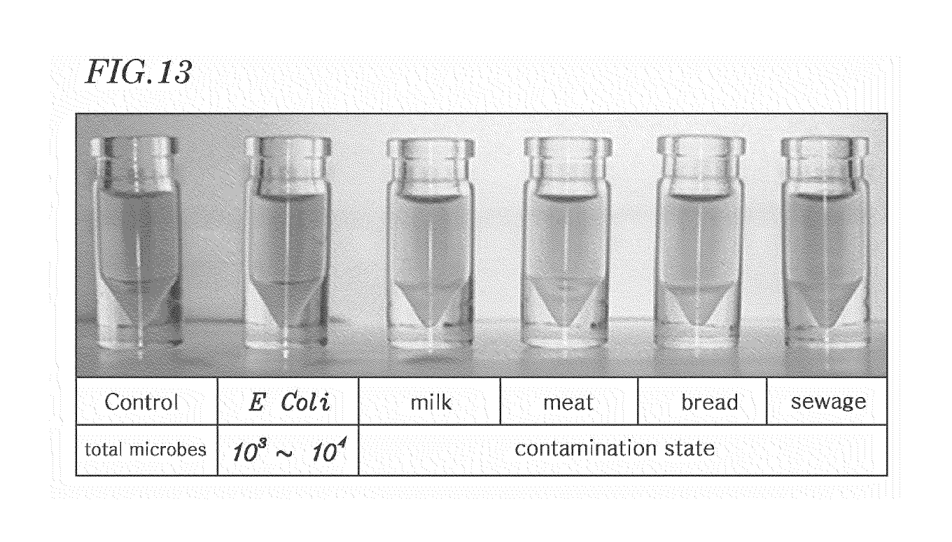

According to the method for the analysis of biological molecules using single-stranded nucleic acid aptamers and gold nano-particles (e.g., Korean Patent Application No. 10-2006-0072480, Korean Patent No. 10-828936), the selected single stranded nucleic acids were used to determine the presence of E. coli and the contamination of foods with E. coli. The results are shown in FIG. 13. The single stranded nucleic acids were incubated in a SELEX buffer with food which had been washed previously, and were reacted with the gold nano-particles after which NaCl was added to the solution. It appeared a pale transparent blue in the absence of E. coli and red in the presence of E. coli. The color intensity was proportional to the quantity of E. coli.

### INDUSTRIAL APPLICABILITY

As described hitherto, the present invention provides a nucleic acid chip for obtaining a binding profile between an unknown biomolecule and single-stranded nucleic acids, a method for manufacturing the chip, and a method for the analysis of an unknown biomolecule using the chip. On the basis of high throughput screening of proteinous substances, the method is very simple and efficient and analysis incurs only a low cost.

Also recently, protein chips and aptamer chips have been developed for high throughput screening of proteinous substances. With the ability to identify unknown biomolecules in microorganisms, viruses, cells and tissues, the method can be applied to various fields including medicine, veterinary science, environmental engineering, food engineering, agriculture and the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for manufacturing a nucleic acid chip, comprising:
reacting a biospecimen containing an unknown biomolecule with random single-stranded nucleic acids having random base sequences to determine biomolecule-binding single stranded nucleic acids capable of binding the unknown biomolecule; and
synthesizing capture single stranded nucleic acids comprising the determined biomolecule-binding single stranded nucleic acids and/or single stranded nucleic acids having base sequences complementary to those of said determined biomolecule-binding single stranded nucleic acids and affixing the capture single stranded nucleic acids on a substrate,
whereby the nucleic acid chip can be used to obtain a binding profile between the single stranded nucleic acids and the unknown biomolecule and thus can be used to analyze biological significance of the unknown biomolecule in the biospecimen.

2. The method according to claim 1, wherein the biomolecule-binding single stranded nucleic acids are determined by:
reacting the random single stranded nucleic acids with the unknown biomolecule of the biospecimen to form biomolecule-single stranded nucleic acid complexes;
washing the biomolecule-single stranded nucleic acid complexes and selecting complexes in which the single stranded nucleic acids are bound to the biomolecule at a predetermined degree or higher on the basis of binding affinity of the single stranded nucleic acids for the biomolecule;
separating the single stranded nucleic acids from the selected complexes and amplifying the single stranded nucleic acids; and
cloning the amplified single stranded nucleic acids into vectors and determining base sequences of the single stranded nucleic acids.

3. The method according to claim 1, further comprising limiting the capture single stranded nucleic acids to a biologically meaningful analytic range of the unknown biomolecule on a basis of degrees of contribution of the capture single stranded nucleic acids to biologically meaningful analysis so as to reduce the capture single stranded nucleic acids in number.

4. The method according to claim 2, further comprising limiting the capture single stranded nucleic acids to a biologically meaningful analytic range of the unknown biomolecule on a basis of degrees of contribution of the capture single stranded nucleic acids to biologically meaningful analysis so as to reduce the capture single stranded nucleic acids in number.

5. The method according to claim 1, wherein the biospecimen is at least one selected from a group consisting of bacteria, fungi, viruses, cells and tissues, and the biomolecule is at least one selected from a group consisting of proteins, carbohydrates, lipids, hydrocarbonates, polysaccharides, glycoproteins, hormones, receptors, antigens, antibodies and enzymes.

6. The method according to claim 2, wherein the biospecimen is at least one selected from a group consisting of bacteria, fungi, viruses, cells and tissues, and the biomolecule is at least one selected from a group consisting of proteins, carbohydrates, lipids, hydrocarbonates, polysaccharides, glycoproteins, hormones, receptors, antigens, antibodies and enzymes.

7. The method according to claim 2, wherein the selecting and the amplifying are repeated many times.

8. A nucleic acid chip for use in obtaining binding profiles between biomolecules and single stranded nucleic acids to analyze the biological significance of unknown biomolecules included in biospecimens, comprising:
a solid substrate on which capture single stranded nucleic acids are affixed, said capture single stranded nucleic acids comprising biomolecule-binding single stranded nucleic acids capable of binding to the unknown biomolecules and/or single stranded nucleic acids complementary to the biomolecule-binding single stranded nucleic acids.

9. A method for analyzing an unknown biomolecule, comprising:
preparing a nucleic acid chip comprising a solid substrate on which capture single stranded nucleic acids are affixed, said capture single stranded nucleic acids comprising biomolecule-binding single stranded nucleic acids capable of binding to the unknown biomolecules and/or single stranded nucleic acids complementary to the biomolecule-binding single stranded nucleic acids;
reacting single stranded nucleic acids identical in base sequence to the capture single stranded nucleic acids of the nucleic acid chip with the unknown biomolecule to form biomolecule-target single stranded nucleic acid complexes and separating the biomolecule-target single stranded nucleic acid complexes;
isolating, amplifying and labeling the target single stranded nucleic acids of the biomolecule-target single stranded nucleic acid complexes;
reacting the labeled target single stranded nucleic acids with the capture single stranded nucleic acids of the nucleic acid chip and obtaining a binding profile from a distribution of the labeled target single stranded nucleic acids over the chip; and
comparing the profile with pre-existing profile data to analyze biological significance of the unknown biomolecule.
